(19) United States
(12) Patent Application Publication
(10) Pub. No.: US 2026/0235776 A1
(43) Pub. Date: Aug. 13, 2026

(54) DIAMOND-BASED MICROFLUIDIC ALPHA SPECTROMETER

(71) Applicant: UNIVERSITY OF TENNESSEE RESEARCH FOUNDATION, Knoxville, TN (US)

(72) Inventor: Eric Daniel Lukosi, Knoxville, TN (US)

(21) Appl. No.: 19/151,189

(22) PCT Filed: Jan. 27, 2024
(86) PCT No.: PCT/US2024/013255

§ 371 Date: Jul. 25, 2025

Related U.S. Application Data
(60) Provisional application No. 63/481,954, filed on Jan. 27, 2023.

(51) Int. Cl. G01T 1/167

(52) U.S. Cl. CPC G01T 1/167

(57) ABSTRACT

Various examples are provided related to diamond-based microfluidic alpha spectrometry. In one example, a diamond-based alpha spectrometer (DiMAS) includes a diamond substrate; one or more microfluidic troughs extending across a surface of the diamond substrate; and electrodes positioned about the microfluidic troughs. The electrodes are supported by the diamond substrate in an arrangement that can collect charge carriers generated from alpha particle interactions in the microfluidic troughs.

### CROSS REFERENCE TO RELATED APPLICATIONS

This application claims priority to, and the benefit of, co-pending U.S. provisional application entitled “Diamond-Based Microfluidic Alpha Spectrometer” having Ser. No. 63/481,954, filed Jan. 27, 2023, which is hereby incorporated by reference in its entirety.

### STATEMENT REGARDING FEDERALLY SPONSORED RESEARCH OR DEVELOPMENT

This invention was made with government support under federal grant number DE-AR0001603 awarded by the Advanced Research Projects Agency-Energy. The Government has certain rights in the invention.

### BACKGROUND

To both understand the uranium and transuranic (TRU) isotopic composition for process monitoring and nonproliferation (plutonium diversion), there is a need for near-real-time material accountancy and control (MC&A) methods for uranium and TRU materials within molten salt media, including both electrochemical processing (pyroprocessing) of used nuclear fuel (UNF) and in liquid-fueled molten salt reactors (LF-MSRs). This also has application in emergency response, nuclear forensics, medical physics, and radiochemistry. In the case of pyroprocessing, at least an elemental level of information is needed for MC&A to know what is in the exiting streams for disposal and recycling as well as identify any missing material (proliferation risk). For LF-MSRs, it is known that cross section data in current databases is not as accurate as desired. A few percent error in just a few cross sections can lead to different reactor power levels, burnup, and LF composition. Since these reactors operate for an extended time, this could lead to significant deviations of observed reactor operation from expected reactor operation. Further, fuel may be periodically added to the primary loop, and knowing how much fuel to add requires an understanding of how much uranium is left. Finally, since plutonium is a natural byproduct of uranium fission reactors, proper accounting is required for nonproliferation concerns. By optimizing fuel consumption and reducing nonproliferation costs via MC&A, the cost to produce non-fossil power can be decreased and their commercial deployment potential enhanced.

### SUMMARY

Aspects of the present disclosure are related to diamond-based microfluidic alpha spectrometry. In one aspect, among others, a diamond-based alpha spectrometer (DiMAS) comprises a diamond substrate; one or more microfluidic troughs extending across a surface of the diamond substrate; and a plurality of electrodes positioned about the one or more microfluidic troughs, the plurality of electrodes supported by the diamond substrate in an arrangement configured to collect charge carriers generated from alpha particle interactions in the one or more microfluidic troughs. In one or more aspects, the diamond substrate can comprise type Ila diamond or electronic grade single-crystal diamond. The size or volume of the diamond substrate can vary depending on the application. For example, the surface of the diamond substrate can have an area in a range from about 10 mm² to about 50 mm² or larger (e.g., as large as 100 mm², 250 mm², 500 mm², 750 mm², or 900 mm²), from about 15 mm² to about 40 mm², or from about 20 mm² to about 35 mm². The surface of the diamond substrate can have an area of about 25 mm². The diamond substrate can be rectangular, square or other appropriate shape. For example, the diamond substrate can be in a range from about 2 mm-25 mm×2 mm-25 mm or larger (e.g., as large as 3 cm×3 cm). The diamond substrate can be about 5 mm×5 mm. A thickness of the diamond substrate can be in a range from about 0.05 mm to about 2 mm, about 0.1 mm to about 1 mm, about 0.2 mm to about 0.75 mm, or about 0.25 mm to about 0.4 mm.

In various aspects, the one or more microfluidic troughs can comprise a plurality of microfluidic troughs extending substantially in parallel across the surface of the diamond substrate. The plurality of microfluidic troughs can be separated by a pitch in a range from about 5 μm to about 40 μm, or by a pitch in a range from about 10 μm to about 20 μm. The one or more microfluidic troughs can have a rectangular, triangular or semi-circular cross-section. The one or more microfluidic troughs can have a square cross-section. Other cross-sections can be used.

In one or more aspects, the plurality of electrodes can comprise first and second groups of interdigitated columns of electrodes positioned adjacent to the one or more microfluidic troughs, each column of electrodes comprising a stack of parallel electrodes extending laterally through the diamond substrate at different depths below the surface of the diamond substrate, each electrode of the stack of parallel electrodes substantially parallel to the adjacent microfluidic trough. The electrodes of each stack of parallel electrodes can be coupled at a first end. All of the interdigitated columns of electrodes of the first group of interdigitated columns of electrodes can be coupled a first electrode pad and all of the interdigitated columns of electrodes of the second group of interdigitated columns of electrodes can be coupled to a second electrode pad. Adjacent electrodes of each stack of parallel electrodes can be separated by a uniform distance. Each stack of parallel electrodes can be positioned between two microfluidic troughs. The plurality of electrodes can comprise graphitic electrodes.

In some aspects, the plurality of electrodes can comprise a plurality of electrode plates positioned on the surface of the diamond substrate on opposite sides of the one or more microfluidic troughs; and a layer of parallel electrodes extending through the diamond substrate at a uniform depth below the surface of the diamond substrate, each electrode of the layer of parallel electrodes substantially parallel to the one or more microfluidic troughs. The plurality of electrode plates can extend along a portion of the one or more microfluidic troughs. Each electrode of the layer of parallel electrodes can be coupled to an electrode pad. The plurality of electrodes can comprise graphitic electrodes.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B illustrate examples of process monitoring options including within the process stream (in-line), closed-loop sampling of the process stream (on-line), or sampling for analysis by the process stream (at-line) or at an off-site laboratory (off-line) and their comparisons, in accordance with various embodiments of the present disclosure.

FIGS. 2A and 2B illustrate alpha spectra observed by a SiC alpha detector after exposure for one hour and from an electroplated U/Th film on a SiC sensor, in accordance with various embodiments of the present disclosure.

FIG. 3A is an image of laser-machined conductive paths into a surface of a diamond substrate, in accordance with various embodiments of the present disclosure.

FIG. 3B illustrates a modeled comparison of the spectral degradation for a 1 μm thin film (planar) on a face of a detector to that observed in 1 μm rectangular and cylindrical MFTs, in accordance with various embodiments of the present disclosure

FIG. 4 is a schematic diagram illustrating an example of a liquid-fueled molten salt reactor (LF-MSR) showing a diamond-based alpha spectrometer (DiMAS) attached to the core unit of an Integral Molten Salt Reactor (IMSR®) for near-real-time on-line measurements, in accordance with various embodiments of the present disclosure.

FIGS. 5A and 5B illustrate an example of a plot of alpha spectra measurements observed with a diamond detector before and after exposure to KCl—LiCl molten salt and time-of-flight secondary ion mass spectrometry after exposure indicating lithium diffusion, in accordance with various embodiments of the present disclosure.

FIGS. 6A-6C illustrate examples of electrode arrangements for the DiMAS, in accordance with various embodiments of the present disclosure.

FIG. 7 illustrates MFT definition in computational fluid dynamic (CFD) modeling, in accordance with various embodiments of the present disclosure.

FIGS. 8A-8C schematically illustrate dimensions of the microchannel with liquid reservoir, extended free surface created for simulating single MFTs surrounded by air, and boundary conditions of test cases for CFD modeling, in accordance with various embodiments of the present disclosure.

FIGS. 9A and 9B illustrate examples of surface wettability effect on capillary-driven wicking in MFTs, in accordance with various embodiments of the present disclosure.

FIGS. 10A and 10B illustrate examples of liquid occupation and filling of microchannels, in accordance with various embodiments of the present disclosure.

FIG. 11A-11C illustrate examples of geometrical effect on liquid filling and propagation in microchannels, in accordance with various embodiments of the present disclosure.

FIGS. 12A-12C illustrate examples of electrode design arrangements for the DiMAS, in accordance with various embodiments of the present disclosure.

FIGS. 13A-13B and 14A-14B illustrate examples of simulated alpha emission spectra for electrode design arrangements of FIGS. 12A and 12B, in accordance with various embodiments of the present disclosure.

### DETAILED DESCRIPTION

Disclosed herein are various examples related to diamond-based microfluidic alpha spectrometry. Reference will now be made in detail to the description of the embodiments as illustrated in the drawings, wherein like reference numbers indicate like parts throughout the several views.

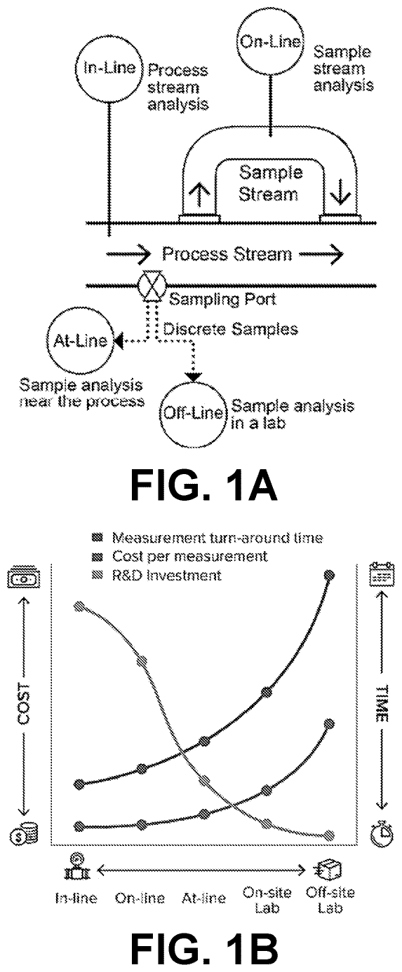

MC&A of uranium and TRU isotopes is challenging because of the high temperatures (~600° C.), corrosive environment, high radiation field, and complex salt composition. Several measurement scenarios can be used to meet the MC&A need in molten salt media, including within the process stream (in-line), closed-loop sampling of the process stream (on-line), or sampling the salt for analysis by the process stream (at-line) or at an off-site laboratory (off-line). FIG. 1A graphically illustrates the process monitoring options based upon location. FIG. 1B shows a qualitative comparison illustrating the trade-off between cost, time to obtain data and location of the measurement. In-line provides the fastest turnaround time but suffers from high R&D costs related to integrating with the process stream, sensor maintenance, and demonstrating reliability in a relevant environment. Off-site (off-line) measurements provide the highest accuracy due to access to high-quality analytical equipment, but also has a slow turnaround time, requires expert users, and is more costly.

In the middle are on-line and at-line measurements. These locations can be adapted to use more accurate systems that are used in a laboratory setting with automation of the sampling and analysis. For this reason, this disclosure presents a high-temperature, chemically resistant, diamond-based alpha spectrometer (DiMAS) for in-line, on-line, at-line and/or off-line analysis of alpha-emitting actinides present within the molten salt. This can also be used to detect low energy x-rays and beta particles. This innovation utilizes the power of alpha spectrometry for MC&A that is typically conducted off-site with processed analysis. DiMAS offers effective, quantitative, on-line isotopic analysis of alpha-emitting isotopes.

Alpha and gamma spectroscopy are valuable MC&A tools because they utilize the radiation emitted by the isotopes of interest, such that they are passive measurement systems. Gamma spectroscopy near a process pipe for on-line monitoring needs temperature and pressure information within the pipe, and even sampling for at-line analysis needs knowledge of the measurement system and environment (e.g., scattering, buildup, detection efficiency) for absolute (quantitative) measurements. However, progress is continuing for safeguards and nuclear security throughout the fuel cycle using an array of transition edge detectors. For at-line evaluations, heavy shielding is needed along with precise knowledge or suitable assumptions to correct for self-absorption of low energy gamma rays within the liquid fueled salt itself.

Alpha spectrometry is attractive because the sensors can be very insensitive to gamma rays. Furthermore, the higher energy of alpha particles vs. common gamma rays stereotypically results in a better energy resolution, which is important for spectroscopic analysis. Unfortunately, the range of alpha particles is only tens of microns in solid matter and only a few centimeters in air. As such, special processing is needed for spectroscopic analysis to remove the intrinsic alpha energy loss within the salt sample, which reduces or removes spectroscopic information. This can be accomplished by dissolving the sample in a liquid scintillation counter (poor energy resolution) or through electrochemical processing.

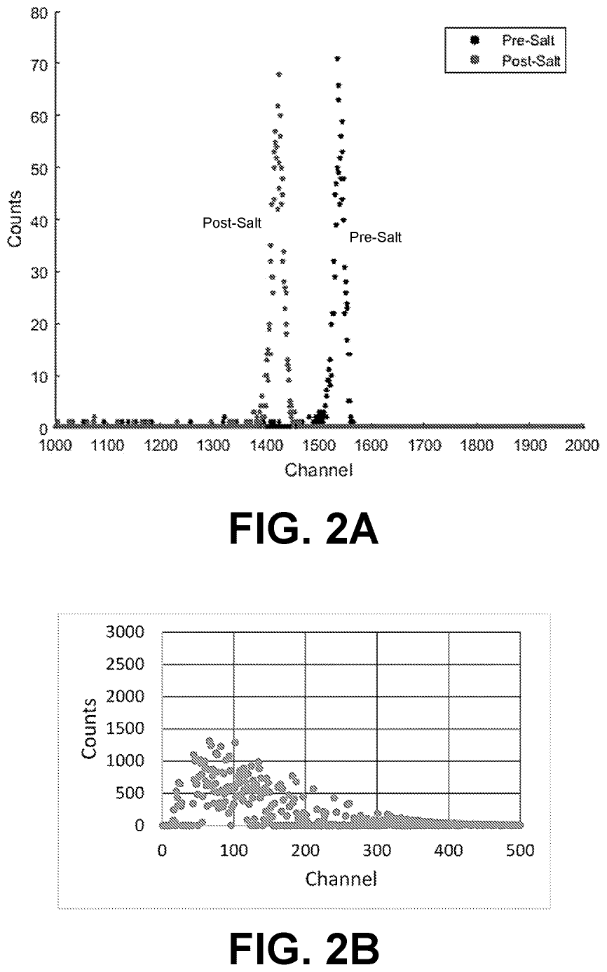

Silicon carbide (SiC) alpha detectors can be used to overcome the alpha spectroscopy challenge for MC&A with molten salt media. The capability of SiC for alpha spectrometry at high temperatures has been demonstrated, with electrodeposition of Th/U on its electrode. The sensor's survivability after a one-hour exposure to a 500° C. molten salt (KCl—LiCl), where some degradation in energy resolution was observed (from 1.36% to 1.70% when biased at −200 V). FIG. 2A illustrates the alpha spectra observed by a SiC alpha detector after exposure for one hour. The peak shifted to the left, suggesting a reduction in the charge collection efficiency (CCE). FIG. 2B shows the observed alpha spectrum from an electroplated U/Th film on a SiC sensor, conducted at room temperature (RT). After U/Th electrodeposition in the molten salt environment, an alpha response was observed, but it did not provide suitable energy resolution to identify the two elements present. The lack energy resolution may be attributed to the sensor not being fully depleted due to breakdown above ~50 V bias, which likely produces a depletion region smaller than the range of alpha particles in SiC. Although it is known that a diffusion component in the non-depleted region can result in an output signal, it typically contributes little to the total signal.

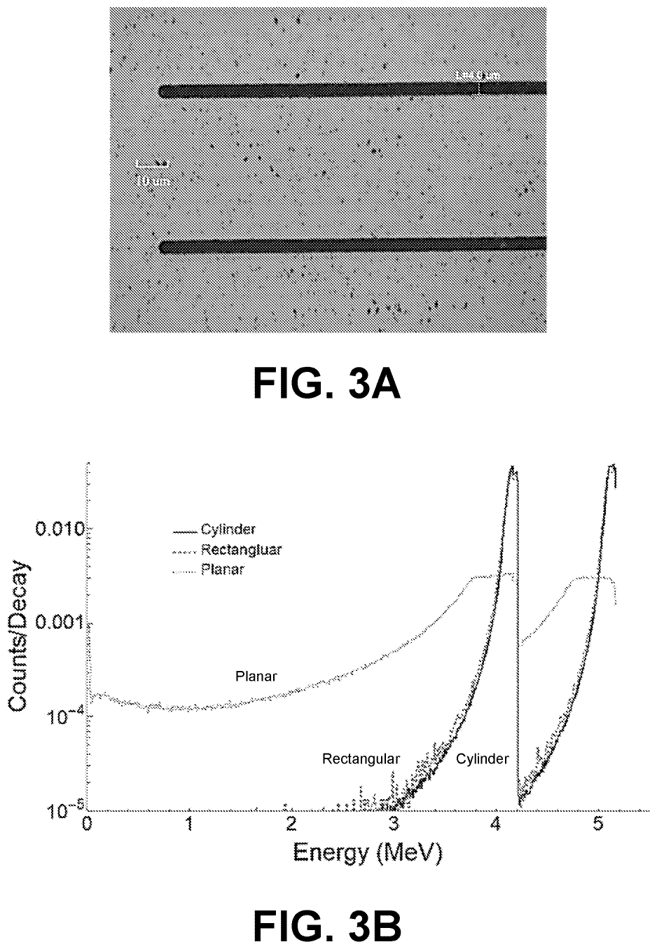

The diamond-based microfluidic spectrometer (DiMAS) is different than the SiC sensor discussed above. To limit the alpha energy loss outside of the active sensing volume that degrades spectral energy resolution and enable on-line or at-line measurements without the need for electrochemical processing, an array of microfluidic troughs (MFTs) are utilized. FIG. 3A is an image of a laser-machined conductive channel into the surface of a diamond substrate at 50× magnification. The value of the MFTs can be seen in FIG. 3B, which shows a modeled comparison of the spectral degradation for a 1 μm thin film (planar) on the face of the detector to that observed in 1 μm rectangular and cylindrical MFTs. The simulated source consists of equal activity of ²³⁸U and ²³⁹Pu. The alpha energy loss is greatly reduced via much less low-energy tailing using cylindrical or rectangular MFT shapes over a thin film as proposed with a SiC detector.

These MFTs are etched into a surface of the diamond substrate with a unique shape that enables them to capture molten salt via, e.g., capillary action. This can also be utilized for other materials that can be inserted into the MFT (e.g., using a centrifuge and nanoparticles or patterned on another surface and inserted). Once the molten salt is captured, the surface of the diamond sensor can be cleared of the remaining molten salt. The sensor can then measure the alpha spectrum and determine the elemental and/or isotopic composition of the alpha emitters within the molten salt (and thus the primary loop in the case of the LF-MSR). Data analysis can be conducted on processing circuitry including a readout and communication board compliant with all regulatory requirements. The on-board analysis via, e.g., FPGA can provide the end-user with the concentrations of all desired isotopes with their uncertainties and spectra may be accessed in the archives for sensor maintenance, calibration, and quality assurance.

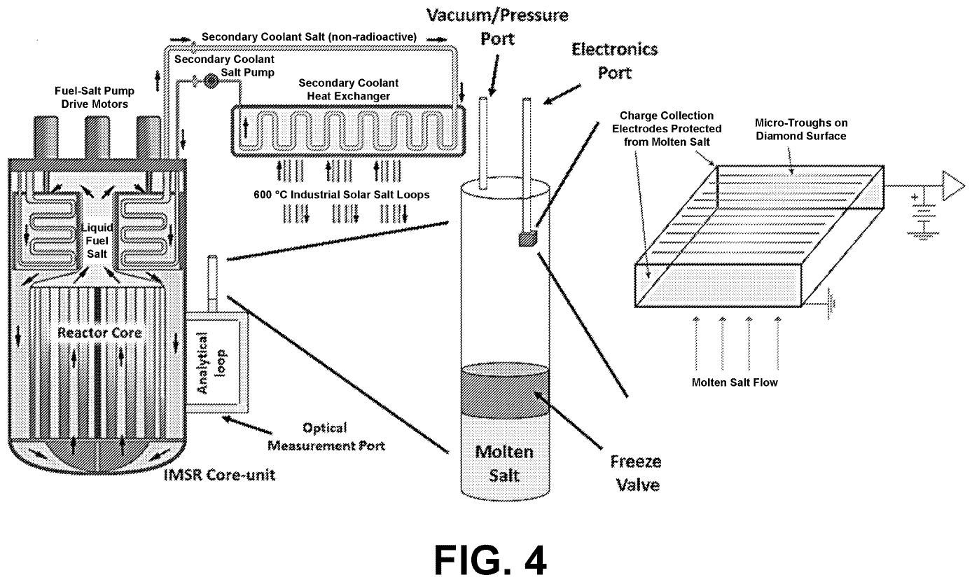

FIG. 4 is a schematic diagram of a liquid-fueled molten salt reactor (LF-MSR) showing a DiMAS attached to the core unit of an Integral Molten Salt Reactor (IMSR®) for near-real-time on-line measurements. In this example, the DiMAS is placed in an analytical loop as illustrated in FIG. 1A for on-line measurements that periodically measure the alpha emitter concentrations. However, the sensor may be placed in other locations as needed by the end-user. For instance, a small footprint DiMAS can also replace an on-site radiochemistry lab for at-line or off-line measurements. The periodicity of the measurements is subject to the needs of the end-user, to include the expected dynamic changes in the process and the sensitivity of the measurements. The sensitivity of the measurement is dependent on the sensor design and the element/isotope under consideration, and the complexity of the process. In the case of the transuranics (TRUs), measuring their concentration to a high sensitivity (~1% or less) can be conducted within minutes, whereas the lower specific activity uranium isotopes can take significantly more time (e.g., on the order of a day or more). However, the value of the DiMAS is its small footprint and fast turnaround time compared to off-line and/or off-site analysis.

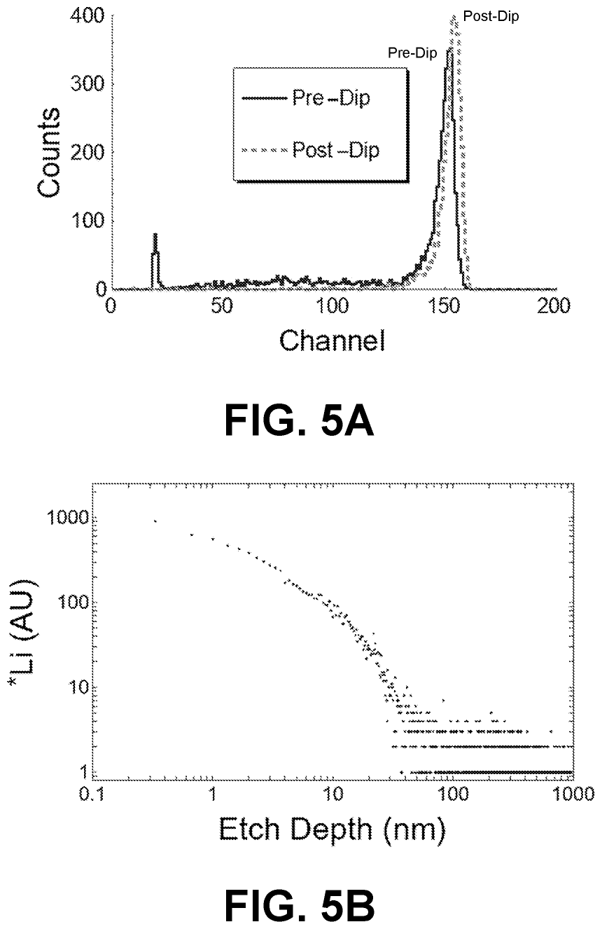

As shown in FIG. 4, the DiMAS includes MFTs in the surface of the diamond substrate to capture molten salt for charge collection by electrodes of the detector. Diamond can survive the molten salt and radiation environment that will be encountered by the DiMAS. Diamond is electrical and mechanically stable in a molten salt and does not require complex sensor structures, supporting the use of diamond for the DiMAS. It has been experimentally demonstrated that diamond is electrically and mechanically stable in a molten salt by exposing it to a 500° C. KCl—LiCl salt cyclically for a total of 5 days. FIG. 5A shows a plot of ²¹⁰Po alpha spectra observed with a diamond detector at RT before and after exposure to a 500° C. KCl—LiCl salt for 5 days. Pre- and post-exposure alpha particle measurements indicated that the charge collection efficiency did not change while it changed within a one-hour exposure for the competing SiC technology. It was also found that lithium diffusion via ToF-SIMS (time-of-flight secondary ion mass spectrometry) did occur, but only penetrated tens of nanometers. FIG. 5B shows the ToF-SIMS data after the 5-day KCl—LiCl eutectic exposure at 500° C. The slow diffusion of lithium into diamond is consistent with other results, indicating that lithium is electrically inactive and does not affect sensor performance.

Concerning temperature stability, the envisioned operation of DiMAS is periodic molten salt exposure and measurement at <300° C. Experimental evidence has shown that diamond sensors start losing their spectroscopic properties around this temperature, likely due to trap activation and hopping conduction, however the diamond sensors may operate at higher temperatures. Concerning radiation tolerance, diamond has tolerance to charged particles and gamma rays, but decreases for ~1 MeV neutrons. Therefore, the DiMAS should avoid operation near sources emitting neutrons of about 1 MeV or greater to reduce exposure, and the small MFT and diamond substrate volumes will limit the P/y fluence. Finally, the periodic temperature cycling and pumping by beta particles will support improved long-term stability and performance via defect annealing and passivation, respectively. Therefore, these results justify the use of diamond as the substrate for the microfluidic spectrometer.

A surrogate actinide composition dissolved in LiCl/KCl was simulated resulting in 79 unique alpha lines from ²³⁴U to ²⁴⁵Cm. Due to the spectral convolution observed by DiMAS, energy windows were used for elemental concentration changes and unique windows for isotopic changes. It was found that energy windowing was effective in sensing small elemental/isotopic chances with a false positive rate of 0.5% at a confidence of 95%. For instance, the time-to-detection (TTD) for a 1% change in the elemental plutonium concentration may be detected in as little as 60 seconds using 9.07×10⁴ microfluidic channels. Assuming a pitch of 20 μm, this results in a total active sensing area of 0.363 cm², which is smaller than the commercially available diamond substrates. For longer-lived elements/isotopes, the TTD can be longer, but the fuel composition will change slowly in an operating nuclear power plant, such that 1-3 days per datum should be sufficient for the intended application of the DiMAS. Furthermore, the volume of the MFTs is very small, such that pulse pileup will be small (minimal spectral degradation). The initial results support the potential of the DiMAS.

MFTs can be fabricated on the surface of the diamond (as shown in FIG. 3A) using a combination of laser processing and reactive ion etching (RIE) or other chemical etching process. Capture of the molten salt by the MFTs can be facilitated via capillary action and excess molten salt can then be removed from the non-MFT surface regions of the diamond substrate, if necessary. The width of the MFTs can be on the order of one micron, with a channel length of millimeters, however these dimensions can be tailored (e.g., larger or smaller) to the needs of the application. The MFT structures and exposure protocols are designed to overcome surface tension limitations and appropriately fill the MFTs while the surface tension holds the molten salt during surface clearing, if necessary. Furthermore, re-exposure of the MFTs to the molten salt may clear the old molten salt and refill them with new salt.

Diamond substrates can comprise diamond that exhibit suitable electron-hole transport properties relevant to the design, e.g., type Ila (test samples) and electronic grade single-crystal diamond (sensor quality material). For example, a lower quality diamond may be used for 25 μm spacing between the surface and buried electrodes. For front and back electrodes (300-500 μm typically), a higher quality diamond (i.e., electronic grade) is needed. The diamond surfaces can be reactive ion etched (RIE) by about 5 μm with an O₂/Ar plasma (or CF₄ or other gas) to remove mechanical damage from lapping and/or polishing. After etching, the diamonds can be prepared for laser etching and/or RIE to form the MFTs in the surface. Laser machining systems can provide 3D sub-micron control which allows the creation of features below the surface of the diamond and enables the creation of unique MFT structures.

In addition to the MFTs, the DiMAS includes electrodes for the alpha measurements. They serve to collect generated charge carriers (electrons and holes) from alpha particle interactions. The amount of charge collected should ideally be the same as that generated by the alpha particles, such that the energy resolution is limited by Poisson statistics. The amount of charge collected can be best described by the mobility (μ) and trapping time constant (τ), where μ indicates how fast the charge carriers move, and τ describes how quickly they recombine. The product μτ with the electric field gives units of distance, called the charge collection distance (CCD), and should be much larger than the inter-electrode distance.

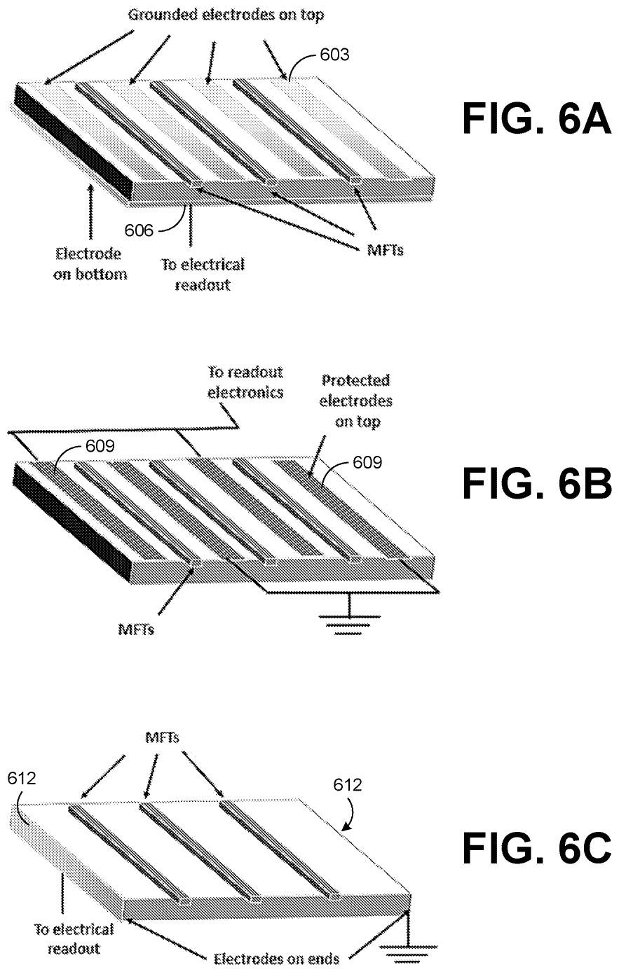

FIGS. 6A-6C graphically illustrate various examples of electrode arrangements for the DiMAS. In the example of FIG. 6A, there are electrodes 603 located between the MFTs that are used to create a near-uniform electric field to the planar bottom electrode 606. The top electrodes 603 can be grounded to limit electro-deposition of the salt. The bottom electrode 606 is used to read out the signal and is not directly exposed to the salt. The electric potential can be any sign and floating (differential) or with respect to a common ground. In the example of FIG. 6B, the electrodes 609 are located between the MFTs and capped with a chemically and electrically resistive material. This example considers readout between electrodes 609 on the surface, but the electric field would be less uniform. As shown, alternating electrodes are grounded and used to read out the signal. In both cases, capping the electrodes adds complexity to the fabrication process. In the example of FIG. 6C, the electrodes 612 are on the end of the diamond substrate and not exposed to the salt via the packaging. This would utilize smaller diamond substrates to reduce the distance between the electrodes and the MFTs, and more of the DiMAS, to ensure the charge collection efficiency is suitably high. Other variations are also possible as will be discussed. The electrodes of the DiMAS can be connected to a charge sensitive preamplifier that converts collected charge to voltage (V=Q/C_{F}). Then it is a simple matter of tallying the observed output voltages and binning them into a differential pulse height spectrum. This can be accomplished using a linear amplifier and a multichannel analyzer or through digital pulse processing.

The diamond substrate itself is resistant to the molten salt, but packaging of the DiMAS should be designed to avoid undue stress (potential cracking) or molten salt leaks to minimize damage, failure of the electrodes or readout connections (wiring), or other structural damage to the DiMAS. This can be improved by use of appropriate epoxies, chemically resistant metals, and gaskets. In addition, minimizing the package size to be only large enough to contain DiMAS (e.g., no more than 5×5×0.3 mm³ per substrate) with a small additional space for the readout lines. The readout lines can exit the package and go directly to the front-end electronics. In some implementations, the readouts can be within the package by increasing the size of the package.

Computational fluid dynamic (CFD) modeling can simulate the interaction of the molten salt with the diamond substrate and MFTs. The CFD modeling can be used to examine the wettability of the diamond surface with a molten salt. As diamond is chemically inert, special passivation layers may be utilized to adjust or enhance wetting of the diamond surface. For example, a passivation layer may be deposited in the MFTs after formation via physical deposition processes or plasma treatments. The layer thickness can be very thin to limit any alpha energy loss in the passivation layer. Further, the surface tension of the molten salt can play a role in how well the MFTs fill with the molten salt. The structure of the MFTs may be designed to enhance capillary action. The desired operational mode of DiMAS is to have multiple uses before replacement (if ever), which would need the solidified salt to be cleared and the MTFs refilled with new salt from the process stream.

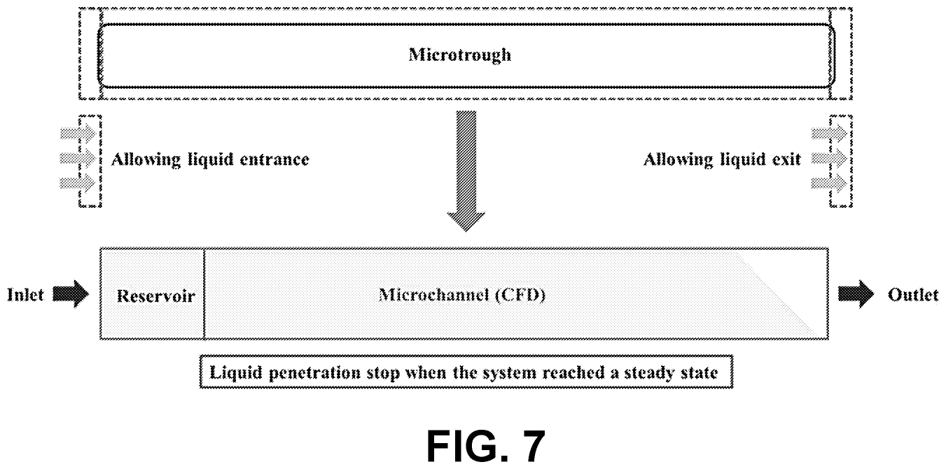

MFT definition in CFD. COMSOL simulation software (version 6.0) was used to conduct the CFD modeling. Unlike microchannels, MFTs do not have inlet and outlet regions allowing liquid entrance and releasement. However, spontaneous capillary flow (SPF) occurs when liquid passes over the MFTs. The bulk liquid will be guided into the channel by capillary forces without any external forces, including the pressure gradient, gravity, and/or inertial force induced by syringe pumps. Thus, a microchannel connected with a liquid reservoir was designed as the test structure to simulate liquid flow characteristics within rectangular MFTs preoccupied with gas, as shown in FIG. 7. The microchannel's inlet and outlet regions were assumed to approach the edge of the MFTs to neglect the calculation error caused by the morphology differences between these two microstructures. Notably, the molten salt (based type) and argon gas with 600° C. operating temperature were used as the working liquid to numerically evaluate the filling status of the molten salt in designed channels.

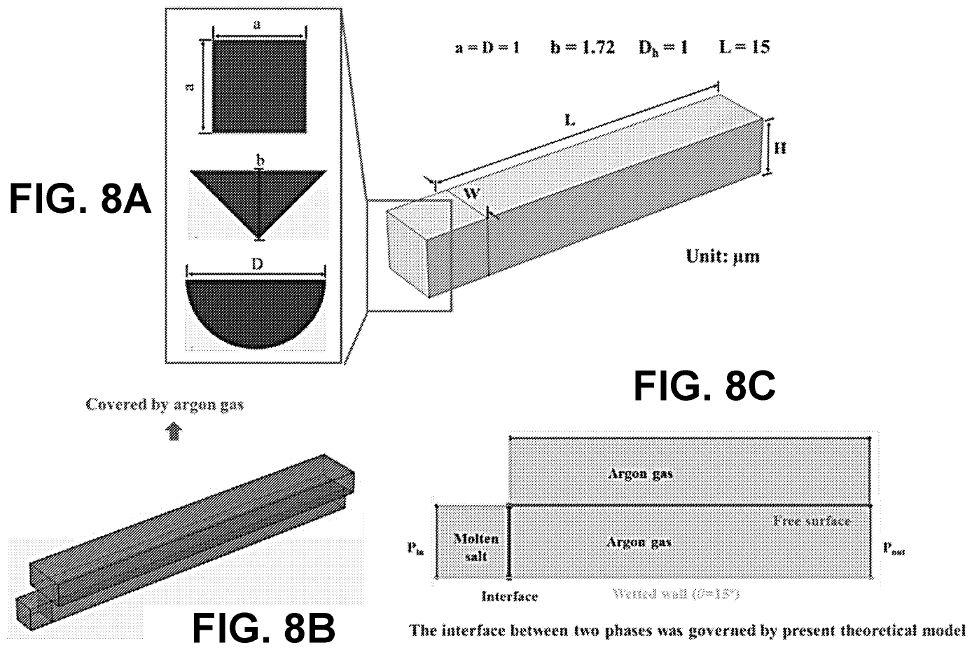

Regarding the dimension and boundary conditions of test cases, microchannels were selected comprising various cross-sectional configurations, including square, triangular, and circular shapes, with a fixed length of 15 μm as the first representative case. The hydraulic diameter of the test cases was 1 μm regardless of the channel shape, as shown in FIG. 8A. The diamond-based microchannel was designed as an open channel preoccupied with argon gas to approach the actual operating conditions. A spatial volume composed of argon gas was covered on the entire open region of the channel, as shown in FIG. 8B. The boundary conditions used in the CFD modeling are shown in FIG. 8C. The pressure at the inlet and outlet regions was assumed to be at atmospheric pressure owing to no additional pressure gradient being affected on the microchannel. In addition, the reservoir wall and the channel bottom were assumed to be the wetted wall with the surface contact angles (θ) of 15 degrees, representing a hydrophilic substrate composed of high adhesion forces to the molten salt.

Theoretical model of capillary-driven wicking estimation. In general, the liquid propagation behavior within circular channels driven by the capillary forces can be evaluated using Washburn's equation:

$${L}^{2} = ( \frac{σ}{μ} \frac{cos {θ}_{A}}{2} ) rt , \qquad ( 1 )$$

where L is the filling distance along the microchannel, σ and μ are the surface tension and dynamic viscosity of liquid, respectively, θ_{A} is the surface contact angle, r is the radius of the circular channel, and t is the time required for the bulk liquid propagation. According to this equation, the microchannel's morphology and surface wettability significantly dominate the filling distance of the bulk liquid. However, this theoretical model is only applicable to evaluate the capillary behavior of the bulk liquid within the circular channel.

Thus, based on Washburn's equation, we provide a new empirical model to determine the filling status of the bulk liquid within the microchannels with different configurations, including square, rectangular, and v shapes. The modified equation is shown in follows:

$${L}^{2} = ( \frac{σ}{μ} \frac{cos {θ}_{A}}{2} ) \frac{{D}_{h}}{2 f R e} {t}^{a} , \qquad ( 2 )$$

where Dₕ is the hydraulic diameter, f is empirical fraction factor, Re is the Reynold number, and power a is fitting factor of time. Here, the Dₕ of the channels is defined as:

$${D}_{h} = \frac{4 A}{P} , \qquad ( 3 )$$

where A is the cross-sectional area and P is the wetted perimeter of the cross-section. Notably, the fitting factor (A) of time depends on experimental results related to the wicking characteristics of the MFTs. This value is assumed as 1 to conduct the CFD modeling in the present disclosure. Furthermore, the Re of all test cases was fixed as a constant because no external liquid-driving force was applied to the open channel.

Grid independence verification and simulation accuracy. To examine the influence of the grid number of the test cases on the numerical result, the square channel with a fixed length of 15 μm was considered. The grid numbers of the test cases varied from 0.05 million to 0.9 million. In general, denser meshes can reduce systematic error while the time cost of calculation is also increased. Thus, using appropriate meshes to construct the CFD model can improve the calculation efficiency without compromising the simulation accuracy. The filling distance estimation of the molten salt was maintained at 88.85 μm. The liquid filling distance of the test cases (Dₕ=1 μm) was mainly dominated by the surface wettability and the cross-sectional geometry. Accordingly, the CFD test case models were constructed with a fixed grid number of 0.6 million to reduce the time cost and simultaneously ensure simulation accuracy. The numerical results of the CFD model were compared to Washburn's equation to determine the simulation accuracy. Only a 0.25% discrepancy in the filling distance between the two models was observed, demonstrating that the present model can be used as a practical approach to estimate the filling status of the working fluid.

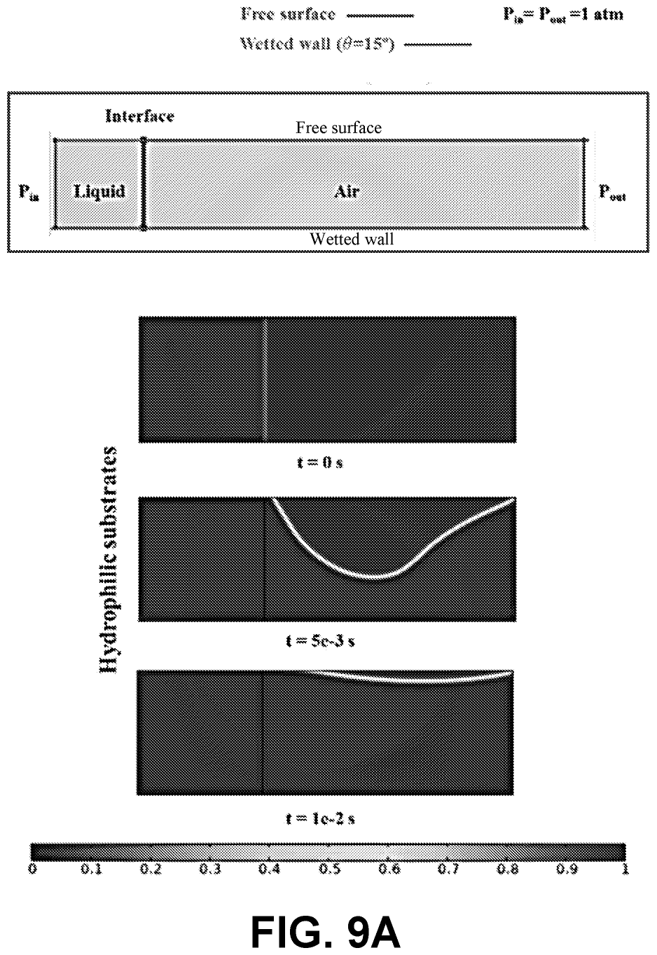

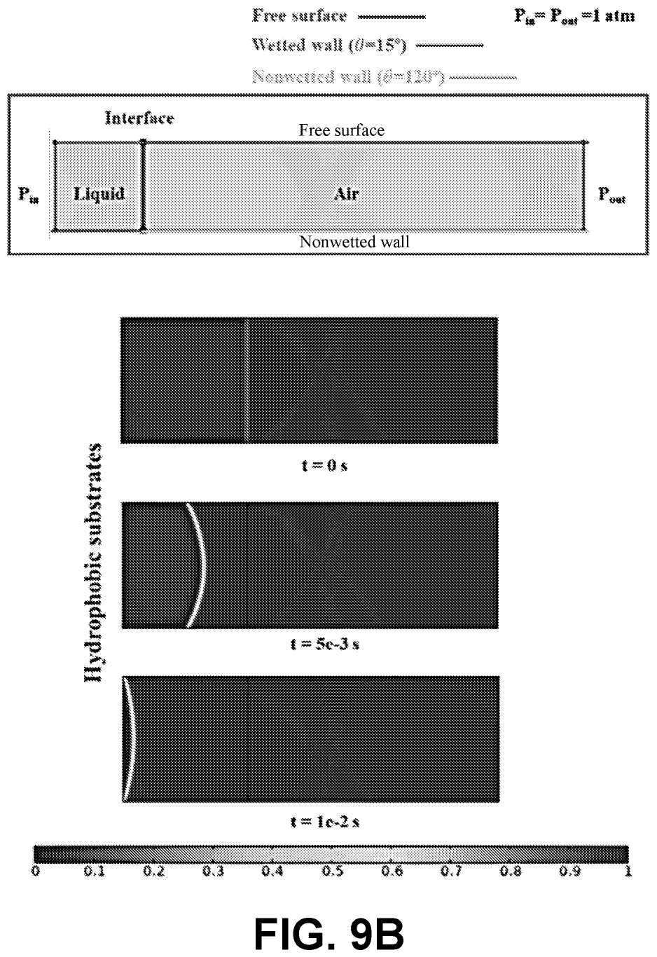

Influence of surface wettability and structural morphology of microchannel on capillary-driven wicking. Structural morphology and surface wettability are factors dominating the capillary behavior of the bulk liquid. Spontaneous capillary flow can occur if the apparent contact angles (CAs) are smaller than the critical CAs, indicating that hydrophobic surfaces will inhibit the bulk liquid passing through the microchannels owing to the low surface energy. CFD modeling was conducted by varying the surface CAs from 15 to 120 degrees to determine the surface wettability effect of the inner channel wall on the capillary-driven wicking. A 1000-μm square channel with 500 μm width and height was selected as the representative design. The liquid meniscus profile of the working fluid was more easily observed by extending the cross-sectional area of the test channel. FIGS. 9A and 9B illustrate examples of surface wettability effect of the microchannels with hydrophilic and hydrophobic substrates, respectively, on the capillary-driven wicking.

Within the same liquid propagation period (0.01 s), the bulk liquid propagated toward the downstream channel and practically occupied the entire channel when the channel wall was hydrophilic surface (=15°), as shown in FIG. 9A. In contrast, the boundary between the bulk liquid and the air moved to the reservoir when the channel was composed of the hydrophobic surface (=120°), as shown in FIG. 9B. These numerical observations illustrate the surface wettability influence on the capillary-driven wicking, in which the SPF phenomenon only occurs on the hydrophilic surface. The channel wall was assumed to be a hydrophilic surface with a constant of 15 degrees to conduct the CFD modeling.

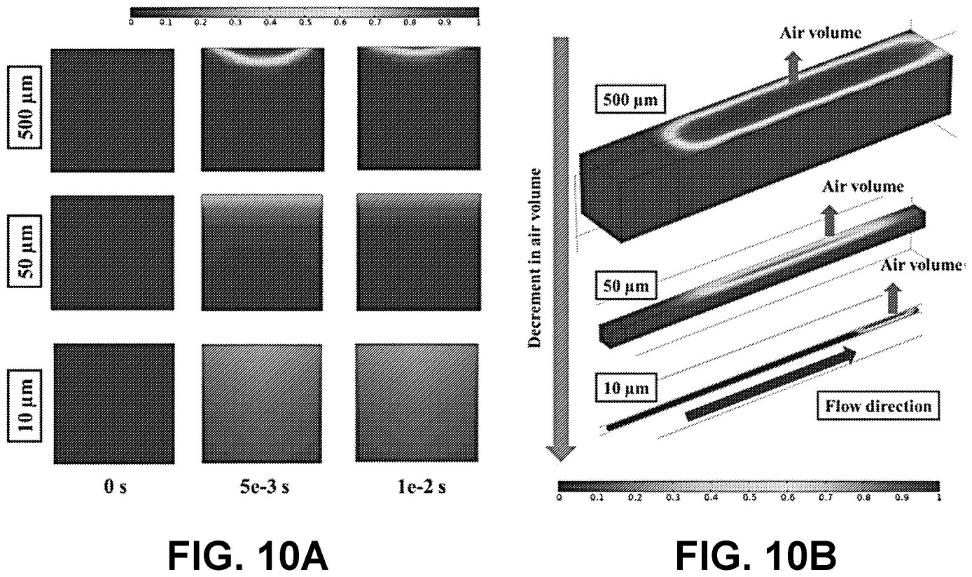

Apart from surface wettability, capillary-driven wicking is also significantly governed by the structural morphology of the microchannel. The morphology effect of microchannels on the liquid occupation status for various test cases is illustrated in FIGS. 10A and 10B. Extending the cross-sectional area of the microchannel can reduce the flow resistance against the liquid flow, whereas the overall capillary pressure will also decrease, deteriorating the filling efficiency of the bulk liquid. FIG. 10A shows the filling status of the bulk liquid within the microchannel with various dimensions, ranging from 10 μm to 500 μm. Among the test cases, a significant meniscus between the liquid and the air can be observed on the 500-μm square channel; on the other hand, the bulk liquid practically occupied the entire microchannel when the channel dimension decreased to 10 μm, showing that the liquid filling efficiency can be effectively improved by shortening the cross-sectional area of the microchannels. In addition, the liquid filling status of the microchannels can be more precisely evaluated in FIG. 10B. When the time needed for the bulk liquid propagation was at 0.01 s, a considerable air volume remained in the microchannel with a 500 μm dimension. In contrast, the bulk liquid significantly replaced the air volume by reducing the channel dimension from 500 μm to 10 μm. Based on the numerical evaluation, the microchannels' surface wettability and structural morphology dominated the capillary-driven wicking. The model revealed a high simulation accuracy for determining the capillary action of the molten salt within the MFTs.

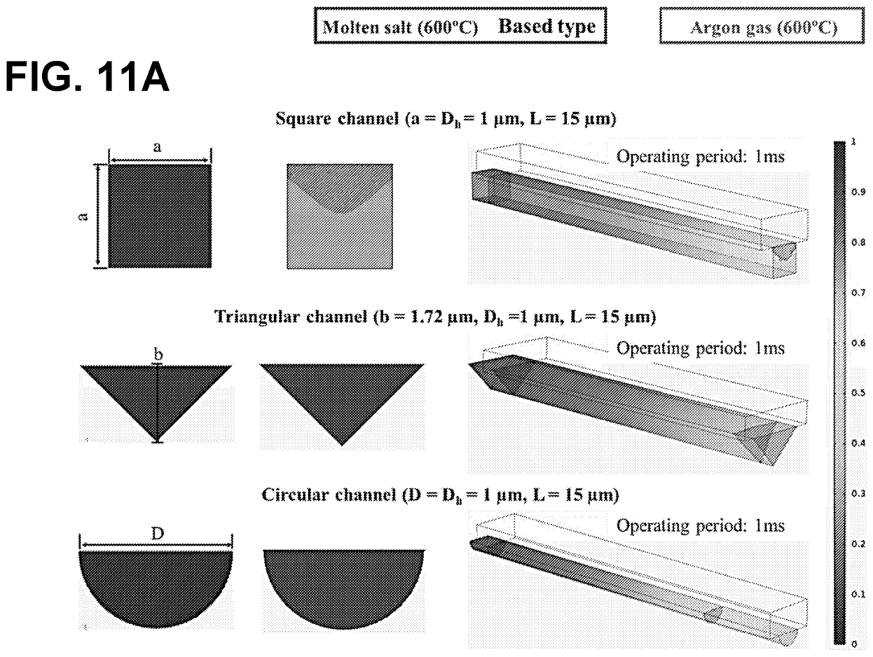

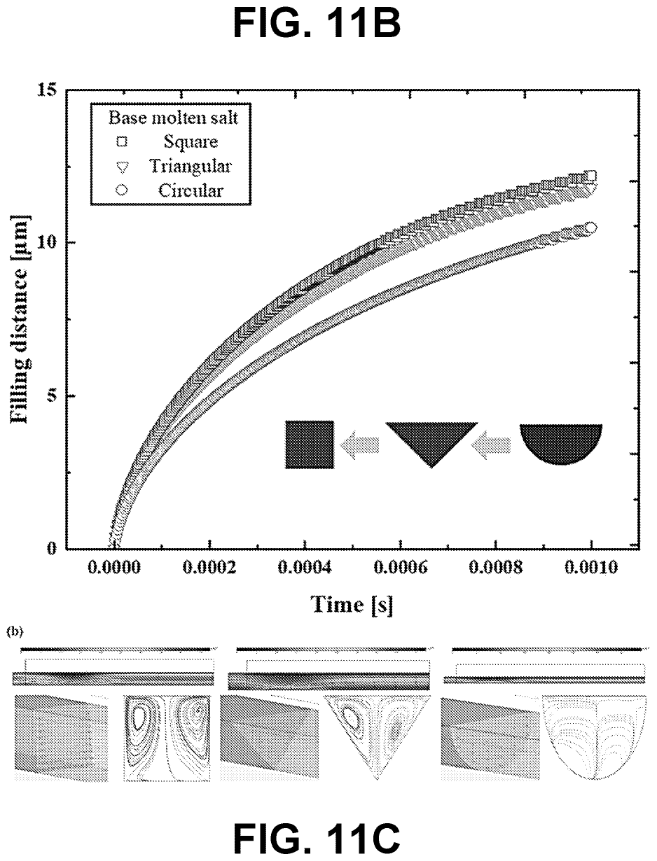

FIG. 11A shows the numerical result regarding the geometrical effect of the test cases on the filling status of molten salts. Microchannels of various cross-sectional shapes, including square, triangle, and circle, with a fixed hydraulic diameter (Dₕ=1 μm) and length of 15 μm were the representatives. The surface contact angle of the molten salt (based type) on the inner channel wall was assumed as 15° (i.e., hydrophilic substrates). With a 1 ms liquid propagation period, the interface between the molten salt and the argon gas could reach the end of the square channel, showing the highest liquid filling efficiency compared to the other comparisons. In contrast, the filling distance of the molten salt for the test channels composed of the triangular and the circular shapes was significantly shorter than the square channel, where the interface between the liquid and gas phases did not reach the channel end during the same working period for the liquid propagation. Hence, the numerical observations indicated that the square channel was the optimal design to ensure an entire occupation of the molten salt among the test cases. However, this may not be the best geometry for energy resolution.

To further quantify the wicking characteristics of the molten salt for the test cases, the relationship between the filling distance and the time needed for liquid propagation in the microchannels was numerically determined. FIG. 11B is a plot illustrating the filing distance versus time needed for the liquid propagation for various cross-sectional shapes. Overall, the filling distance of the molten salt of the test cases increased with extended liquid propagation periods. Among the test cases, the square channel resulted in the highest filling distance of the molten salt (12.2 μm) compared to the test channel comprising the triangular (11.8 μm) and the circular shapes (10.5 μm) within 1 ms. The underlying mechanism of the geometrical effect of the test cases on the liquid filling efficiency can be further evaluated with the velocity contour of the microchannel with square, triangular, and circular shapes with a fixed liquid propagation period of 0.1 ms. FIG. 11C illustrates the velocity contours of the square, triangular and circular shapes with a fixed liquid propagation period of 0.1 ms. The square channel revealed the highest filling velocity within the downstream channel compared to the triangular and circular channels. Further, considerable vortex profiles were observed from the interfacial region of the square channel, indicating that the microchannel composed of the square shape could accelerate the liquid propagation, thus ensuring full occupation.

The electrode arrangements for the DiMAS can be varied to enhance or improve the energy resolution. While FIGS. 6A-6C illustrate electrode arrangements positioned on the surfaces of the diamond substrate, the electrodes can be arranged in other configurations about the MFTs to improve for the alpha measurements. For example, a first design can include an interdigitated set of column electrodes supported by the diamond substrate and a second design can include a plate as one electrode and a set of electrodes underneath the plate as another electrode. The electrodes can be graphitic electrodes/plates (or can be formed of other appropriate material, such as, but not limited to, nano-diamond, graphite, and amorphous carbon). The extension into the diamond substrate can be about 25 μm to account for the range of the most energetic alpha particles exiting from the MTF.

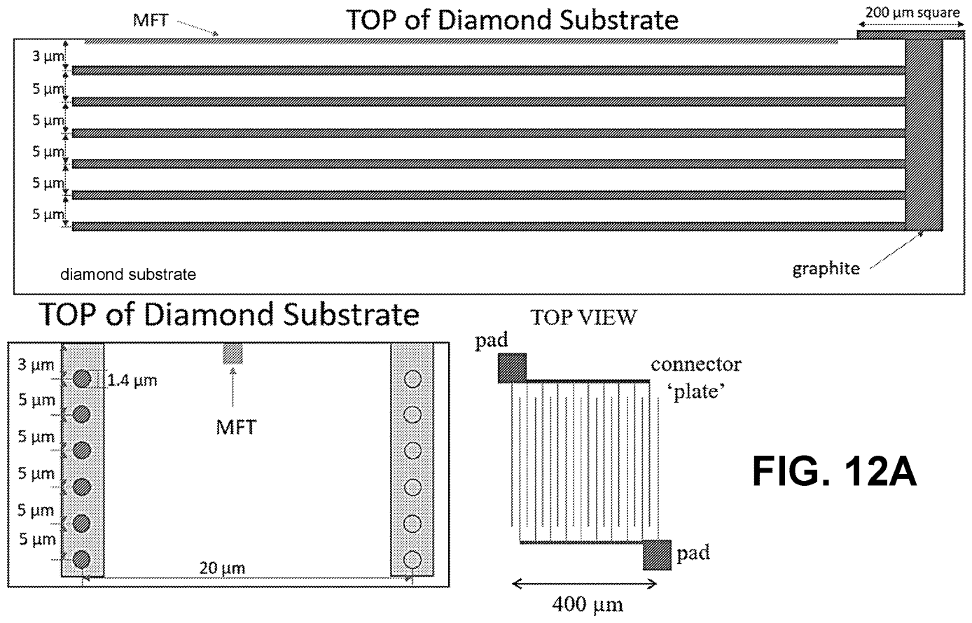

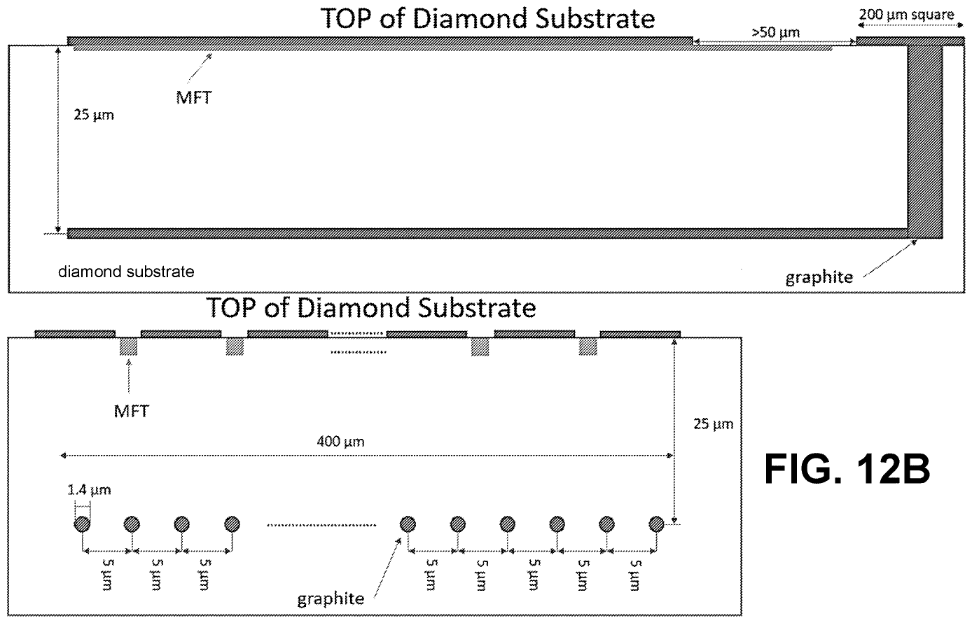

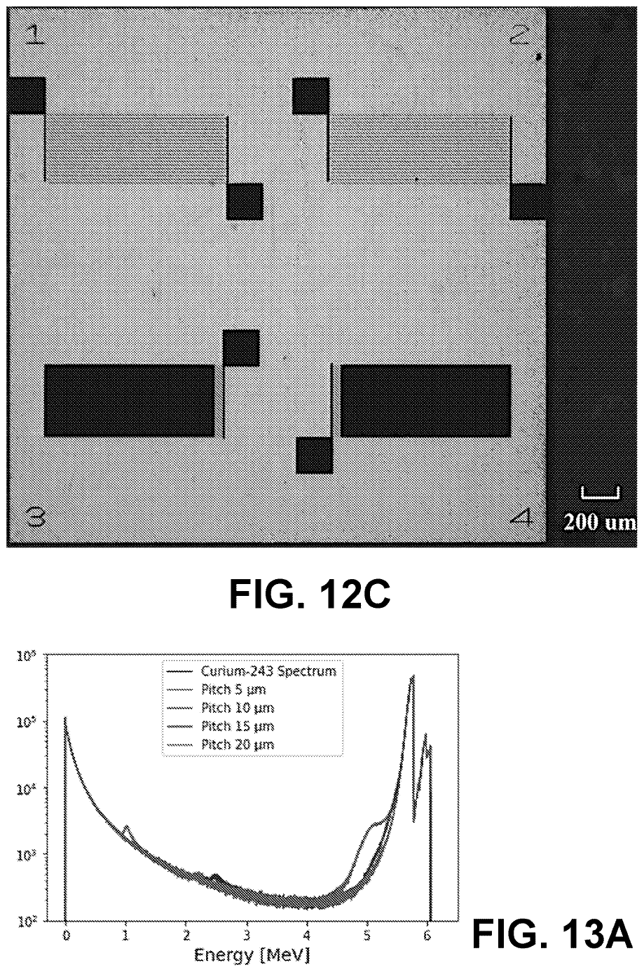

FIG. 12A illustrates side views and a top view of an example of the interdigitated column electrode design comprising columns of electrodes extending through a diamond substrate between the MTFs. The electrodes are coupled to an electrode pad via a connector plate or via and extend substantially parallel to and along the length of the one or more MTF on the surface of the diamond substrate. The electrodes in each column are located at different depths in the diamond substrate below the MTF(s). For example, the electrodes can be evenly separated from each other as shown in FIG. 12A (e.g., by a distance of about 5 μm, beginning about 3 μm below the surface of the diamond substrate). The columns of electrodes can be distributed (e.g., about 20 μm apart) with the MTF approximately centered between the columns for uniform sensing. For a single readout, all of the interdigitated columns of electrodes of a group would be coupled to a common electrode pad as shown in FIG. 12A. For multiple readouts, different sets of the interdigitated columns of electrodes would be coupled to different electrode pads. For example, a number of adjacent columns can be grouped together or every n-th column can be grouped together to define a set.

FIG. 12B illustrates side views of an example of the plate and electrode design comprising layer of electrodes extending through a diamond substrate below the plates and MTFs. The electrodes are coupled to an electrode pad via a connector plate or via and extend substantially parallel to and along the length of the one or more MTF on the surface of the diamond substrate. While the electrodes are shown extending substantially parallel to and along the length of the one or more MTFs, the direction of the electrodes can be varied with respect to the MTFs. For example, in other implementations, the electrodes can extend substantially perpendicular to the length of the one or more MTF. As shown in FIG. 12B, the plates extend between the MTFs on the surface of the diamond substrate opposite the electrodes. For example, the electrodes can be evenly distributed below the MTFs as shown in FIG. 12B (e.g., by a distance of about 5 μm, at a depth of about 25 μm below the surface of the diamond substrate). The plates and electrodes can be distributed beyond the MTFs (e.g., by about the width between adjacent MFTs). Appropriate separation between the plate and electrode pad is provided to ensure proper clearing of the molten salts from the MFTs.

Electrode materials can include titanium, chromium, tungsten, gold, nickel-chromium, molybdenum, niobium, zirconium, and alloys thereof. Given the harsh effects due to molten salt exposure, adhesion of the metal to the diamond substrate poses special considerations. Treatments and coatings can be applied to protect the metals formed on the surface of the diamond substrate. Graphitic electrodes created from the diamond substrate itself offer an alternative. Graphite is not readily attacked by molten salts. In addition, using buried electrodes provides a third dimension to optimize the sensor response, including greatly decreasing the charge collection distance. This method has been studied to create 3D diamond detectors for particle tracking at the Large Hadron Collider. A set of experiments were conducted to create graphitic electrodes on the diamond surface using laser machining. All designs were created with 1.4 μm graphitic channels. Each design is repeated with one using 300 fs pulses and the other uses about 1 ps pulses from the laser. An image of the resulting substrate with the two fabricated designs on the diamond substrate (the interdigitated column electrode design on the top and the plate and electrode design on the bottom) is provided in FIG. 12C. On the back side of the diamond, a series of sub-surface wires was created with their own readout graphitic pads to measure the variability in resultant resistivity of the channels.

A series of MCNP simulations were conducted to evaluate the effect of the DiMAS sensor design on the spectral performance of the detector. The focus was on the diameter and pitch of cylindrical troughs and the effect of buried graphitic electrodes. The first set of simulations was to verify the effect of pitch between 1 μm cylindrical troughs ranging from 5 μm to 20 μm on the spectral output due to energy loss in non-sensing regions (i.e., adjacent MFTs). The most energetic emitted alpha particle is from Cm-243, and its range in diamond is approximately 18 μm. Therefore, a complete overlap is expected between the 20 μm pitch and single MFT spectra.

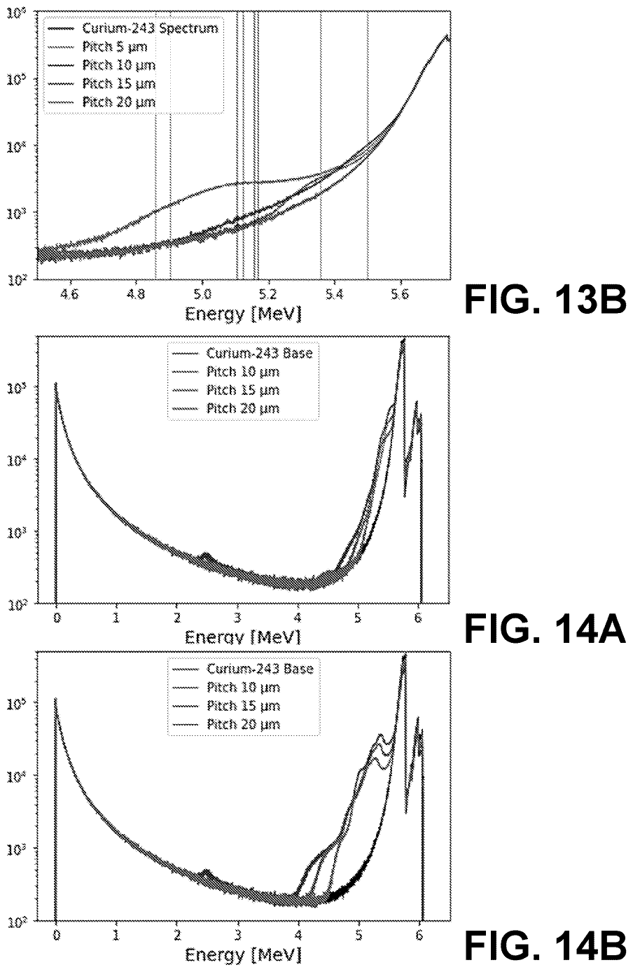

FIG. 13A is a plot illustrating the resulting alpha spectra from Cm-243 with 1 μm diameter cylindrical troughs as a function of differing trough pitches (distance between MFTs). FIG. 13B is focused on the alpha emission range of all relevant plutonium isotopes (238, 239, 240, and 242) represented as vertical lines. These results indicate that a 5 μm pitch exhibits an order of magnitude higher counts inside the energy window of plutonium isotope alpha emission energies, such that this or a similar pitch is not a desirable design for the DiMAS.

The next set of simulations focused on the effect of buried graphitic electrodes on the resultant alpha spectrum. The two simulated designs are consistent with the designs illustrated in FIGS. 12A and 12B. The resulting spectra for the interdigitated column electrode design as a function of trough pitch is provided in FIGS. 14A and 14B for graphitic electrode diameters of 1 μm and 2 μm, respectively. In design A, the pitch between the graphitic electrodes matches that of the MFTs, such that the electrodes can also contribute to spectral degradation. Upon comparison with FIG. 13A, it is apparent that there is an effect beyond energy loss in adjacent MFTs. Therefore, the electrode location, electric field profile for charge collection, and diameter of the graphitic electrode should be considered. For the plate and electrode design, since the electrodes are beyond the range of the Cm-243 alpha particles in diamond substrate, the resulting spectra were identical to that in FIG. 13A.

Mechanisms for the charging and discharging of molten salt from the MFTs in the diamond substrate can be examined using a testbed. For example, molten salt can be supplied from a small vessel as a surrogate for a spent fuel tank. The target mechanism for charging the MFTs can involve dipping the sensor into the molten salt for a brief period. A high-pressure argon gas jet can remove excess molten salt from the surface of the diamond substrate before spectroscopic analysis. An optical system can be used evaluate salt uptake and discharge from the MFTs. Vacuum filling of a vessel containing the diamond substrate offers an alternate charging mechanism. Salt can be discharged from the MFTs via diffusion during subsequent dipping operations. Mechanisms for the removal of excess molten salt from the non-MFT region of the substrate surface can also include argon or other gas jet and/or doctor blade mechanisms.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A diamond-based alpha spectrometer (DiMAS), comprising:
a diamond substrate;
one or more microfluidic troughs extending across a surface of the diamond substrate; and
a plurality of electrodes positioned about the one or more microfluidic troughs, the plurality of electrodes supported by the diamond substrate in an arrangement configured to collect charge carriers generated from alpha particle interactions in the one or more microfluidic troughs.

2. The DiMAS of claim 1, wherein the diamond substrate comprises type Ila diamond or electronic grade single-crystal diamond.

3. The DiMAS of claim 1, wherein the surface of the diamond substrate has an area of about 25 mm².

4. The DiMAS of claim 3, wherein the diamond substrate is about 5 mm×5 mm.

5. The DiMAS of claim 3, wherein a thickness of the diamond substrate is in a range from about 0.25 mm to about 0.4 mm.

6. The DiMAS of claim 1, wherein the one or more microfluidic troughs comprises a plurality of microfluidic troughs extending substantially in parallel across the surface of the diamond substrate.

7. The DiMAS of claim 6, wherein the plurality of microfluidic troughs are separated by a pitch in a range from about 5 μm to about 40 μm.

8. The DiMAS of claim 7, wherein the plurality of microfluidic troughs are separated by a pitch in a range from about 10 μm to about 20 μm.

9. The DiMAS of claim 1, wherein the one or more microfluidic troughs have a rectangular, triangular or semi-circular cross-section.

10. The DiMAS of claim 9, wherein the one or more microfluidic troughs have a square cross-section.

11. The DiMAS of claim 1, wherein the plurality of electrodes comprises first and second groups of interdigitated columns of electrodes positioned adjacent to the one or more microfluidic troughs, each column of electrodes comprising a stack of parallel electrodes extending laterally through the diamond substrate at different depths below the surface of the diamond substrate, each electrode of the stack of parallel electrodes substantially parallel to the adjacent microfluidic trough.

12. The DiMAS of claim 11, wherein the electrodes of each stack of parallel electrodes are coupled at a first end.

13. The DiMAS of claim 11, wherein all of the interdigitated columns of electrodes of the first group of interdigitated columns of electrodes are coupled a first electrode pad and all of the interdigitated columns of electrodes of the second group of interdigitated columns of electrodes are coupled to a second electrode pad.

14. The DiMAS of claim 11, wherein adjacent electrodes of each stack of parallel electrodes are separated by a uniform distance.

15. The DiMAS of claim 11, wherein each stack of parallel electrodes is positioned between two microfluidic troughs.

16. The DiMAS of claim 11, wherein the plurality of electrodes comprises graphitic electrodes.

17. The DiMAS of claim 1, wherein the plurality of electrodes comprises:
a plurality of electrode plates positioned on the surface of the diamond substrate on opposite sides of the one or more microfluidic troughs; and
a layer of parallel electrodes extending through the diamond substrate at a uniform depth below the surface of the diamond substrate, each electrode of the layer of parallel electrodes substantially parallel to the one or more microfluidic troughs.

18. The DiMAS of claim 17, wherein the plurality of electrode plates extend along a portion of the one or more microfluidic troughs.

19. The DiMAS of claim 17, wherein each electrode of the layer of parallel electrodes is coupled to an electrode pad.

20. The DiMAS of claim 17, wherein the plurality of electrodes comprises graphitic electrodes.
